(19) United States
(12) Patent Application Publication
(10) Pub. No.: US 2018/0088004 A1
(43) Pub. Date: Mar. 29, 2018

(54) FUEL SYSTEM SMART NODE

(71) Applicant: SIKORSKY AIRCRAFT CORPORATION, Stratford, CT (US)

(72) Inventors: Patrick W. Kalgren, Conesus, NY (US); Brian Drost, Fairport, NY (US); Kenneth Gravenstede, Lima, NY (US)

(21) Appl. No.: 15/557,953

(22) PCT Filed: Jan. 13, 2016
(86) PCT No.: PCT/US16/13152

§ 371 Date: Sep. 13, 2017

Related U.S. Application Data
(60) Provisional application No. 62/134,353, filed on Mar. 17, 2015.

(51) Int. Cl. G01M 15/05; F02D 41/22

(52) U.S. Cl. CPC G01M 15/05; F02B 77/08; F02D 2041/224; F02D 41/22

(57) ABSTRACT

A measuring system, method, and/or computer program that realizes physics-based relations between sensor readings to monitor for degradations and predict failures of power systems is provided. For example, the supply and return of fuel in a power system is provided by a fuel injection system. The fuel injection system responds to changes in loads and system conditions, such as to compensate for fuel loss due to fuel combustion, by continuously and instantaneously changing the fuel flow. This behavior by the fuel injection system creates characteristic signatures. These characteristic signatures are instantaneously detected and utilized by the measuring system, method, and/or computer program to detect healthy, degrading, failing, and failed mechanical conditions so as to monitor for degradations and predict failures of the power system.

### STATEMENT REGARDING FEDERALLY SPONSORED RESEARCH AND DEVELOPMENT

This invention was made with government support with the United States Army under Contract No. W31P4Q-10-C-0115. The government therefore has certain rights in this invention.

### BACKGROUND

The disclosure relates generally to power systems and, more specifically, to tracking individual unit fuel consumption and providing operational feedback regarding day to day performance of the power systems.

In general, an electric generator consumes a fuel to generate three-phase alternating current power outputs. For instance, the fuel consumed by the electric generator creates mechanical energy from fuel combustion to turn a crank on a generator to create a three-phase alternating current electrical output. Generators often degrade and break, which prolongs operational downtime and incurs monetary expenses for maintenance of the electric generator. In addition, during degradation, the electric generator consumes more fuel, which increases the monetary expenses of operating the electric generator.

Some electric generators include a fuel injection system that can respond to operation conditions and degradation by adding fuel and modifying injection timing. However, a component failure of the fuel injection system may also lead to operational downtime and/or costly failures of the electric generator itself.

### SUMMARY

According to one embodiment of the present invention, a device for computing a health of an engine is provided, the device being communicatively coupled to at least two sensors, a first sensor of the at least two sensors being physically coupled to fuel supply to the engine, a second sensor of the at least two sensors being physically coupled to fuel return from the engine, the device configured to: receive a sensor data from the at least two sensors that includes an in-flow detected by the first sensor and an out-flow detected by the second sensor; process the sensor data to derive signature differences; and diagnose the health of the engine based on the signature differences.

According to another embodiment or the device embodiment described above, the sensor data can be a precise and instantaneous detection of flow rates into and out of the engine.

According to another embodiment or any of the device embodiments described above, the device can be configured to determine from the diagnoses of the health of the engine a prognosis for degradations and failures of the engine.

According to another embodiment or any of the device embodiments described above, the signature differences can include fluctuations in the sensor data between the in-flow of the fuel supply and the out-flow of the fuel return.

According to another embodiment or any of the device embodiments described above, the device can be configured to receive additional sensor data from voltage and current sensors coupled to an electrical output of the engine; and diagnose the health of the engine based on the signature differences and the additional sensor data.

According to another embodiment or any of the device embodiments described above, the device can be coupled with the at least two sensors and the engine in a self-contained smart node system.

According to one embodiment of the present invention, a method for computing a health of an engine coupled to at least two sensors is provided, a first sensor of the at least two sensors being physically coupled to fuel supply to the engine, a second sensor of the at least two sensors being physically coupled to fuel return from the engine, the method comprising receiving a sensor data from the at least two sensors that includes an in-flow detected by the first sensor and an out-flow detected by the second sensor; processing the sensor data to derive signature differences; and diagnosing the health of the engine based on the signature differences.

According to another embodiment or the method embodiments described above, the sensor data can be a precise and instantaneous detection of flow rates into and out of the engine.

According to another embodiment or any of the method embodiments described above, the method can further comprise determining from the diagnoses of the health of the engine a prognosis for degradations and failures of the engine.

According to another embodiment or any of the method embodiments described above, the signature differences can include fluctuations in the sensor data between the in-flow of the fuel supply and the out-flow of the fuel return.

According to another embodiment or any of the method embodiments described above, the method can further comprise receiving additional sensor data from voltage and current sensors coupled to an electrical output of the engine; and diagnosing the health of the engine based on the signature differences and the additional sensor data.

According to another embodiment or any of the method embodiments described above, the method can be embodied as computer readable instruction within a non-transitory medium of a device, wherein the device is coupled with the at least two sensors and the engine in a self-contained smart node system.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 illustrates a power system for employing a measuring system;

FIG. 2 illustrates a process flow of a measuring system; and

FIG. 3 illustrates a schematic of a computing device of a process flow of a measuring system.

### DETAILED DESCRIPTION

As indicated above, degradation and failure of electric generators and fuel injection systems of these generators lead to costly downtown and expenses. Thus, what is needed is a methodology and/or mechanism to track individual unit fuel consumption and provide operational feedback regarding day to day performance of the power systems.

In general, embodiments of the present invention disclosed herein may include a measuring system, method, and/or computer program product (herein generally referred to as ‘the measuring system’) that realizes physics-based relations between sensor readings to monitor for degradations and predict failures of power systems. For example, the supply and return of fuel in a power system is provided by a fuel injection system. The fuel injection system responds to changes in loads and system conditions, such as to compensate for fuel loss due to fuel combustion, by continuously and instantaneously changing the fuel flow. This behavior by the fuel injection system creates characteristic signatures. These characteristic signatures are instantaneously detected and utilized by the measuring system to detect healthy, degrading, failing, and failed mechanical conditions so as to monitor for degradations and predict failures of the power system.

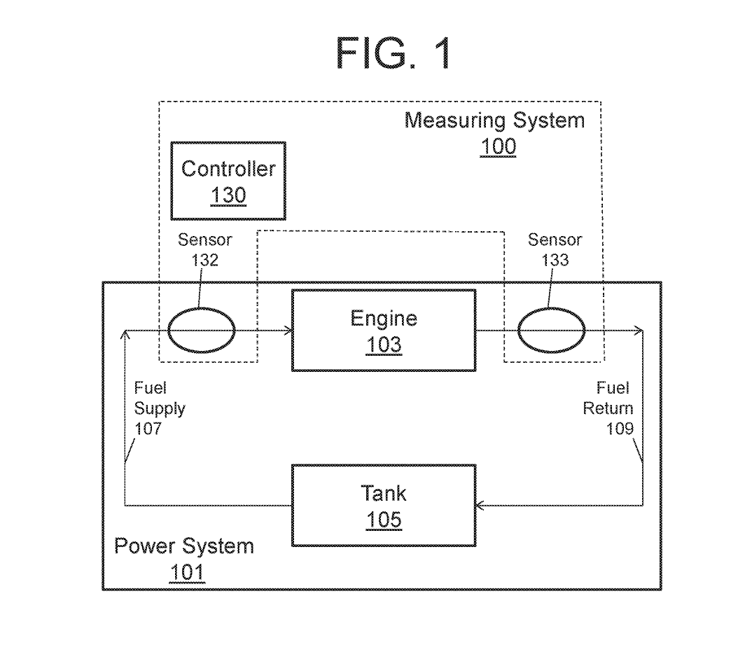

Turning to FIG. 1, a measuring system 100, as represented by dashed-box, is depicted attached to a power system 101. The power system 101 includes an engine 103 and a tank 105. The engine 103 receives fuel from the tank 105 via a fuel supply 107 and returns fuel to the tank via fuel return 109.

The engine 103, in general, is any mechanical device designed to convert one form of energy into another. The tank 105 may be any container, vessel, or source that stores and supplies fuel to the engine 103. For example, the engine 103 can be a generator that converts mechanical energy to electrical energy for use in an external circuit. Examples of the engine 103 may be a gas turbine engine, a diesel generator, etc. Thus, the source of mechanical energy may include an internal combustion engine that utilizes fuel, such as diesel gasoline, to rotate a crank that creates power for the power system 101.

The measuring system 100 includes a controller 130 that is commutatively coupled to a plurality of sensors (e.g., at least two sensors 132, 133). The outputs or sensor data of the at least two sensors 132, 133 are received and processed by the controller 130. The controller may utilize a software algorithm to solve for various conditions, including mechanical degradation. In this way, the measuring system 100 can reliably and automatically measure and process fuel flow, among other parameters, of the power system 101 via a software algorithm and a sensor orientation scheme.

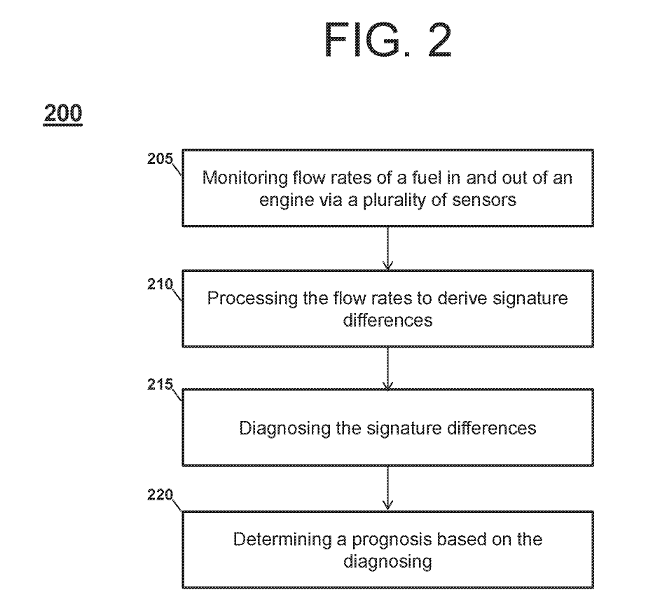

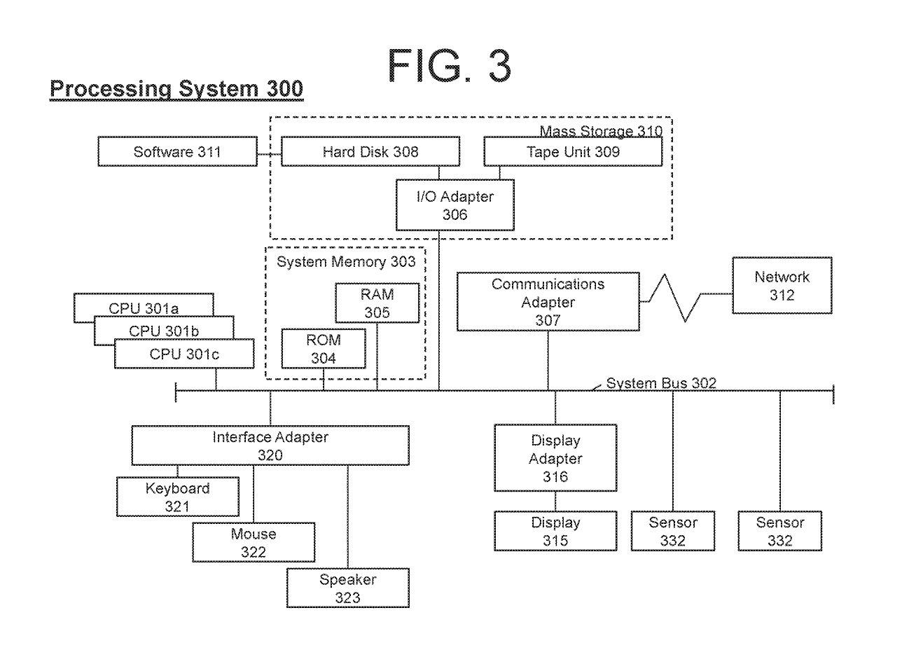

The controller 130 and the at least two sensors 132, 133 can be incorporated with or external to each other, such that the measuring system 100 is a self-contained system that can be adapted to any power system 101 (e.g., a smart node) or a component system divided amongst multiple computing and/or power systems. Further, the measuring system 100, the controller 130, and the at least two sensors 132, 133 may include and/or employ any number and combination of sensors, computing devices, and networks utilizing various communication technologies, as described below, that enable the measuring system 100 to perform the measuring processes, as further described with respect to FIG. 2. Thus, the measuring system and elements therein of the Figures may take many different forms and include multiple and/or alternate components and facilities (e.g., being connected to a health and usage management system to monitor for degradations and predict failures). And, while the measuring system 100 is shown in FIG. 1, the components illustrated in FIG. 1 and other FIGS. 2-3 are not intended to be limiting. Indeed, additional or alternative components and/or implementations may be used.

The controller 130 may be any processing system (as further described below with respect to FIG. 3), processor, and/or combination thereof. The controller 130 executes algorithms on sensor data (e.g., fuel flow rates) to detect faults and predict potential future faults within the power system. As noted above, the controller 130 may be co-located with the sensors 132, 133 inside the power system 101, which is referred to as a “smart node.”

Sensors, such as the sensors 132, 133, are devices that measure physical quantities and convert these physical quantities into a signal output (e.g., sensor data) that is read by the controller 130. The sensors 132, 133 can be strain gauges that measure the physical stress applied to the fuel supply 107 and/or fuel return 109; temperature sensors that measure the temperature characteristics and/or the physical change in temperature of the fuel supply 107 and/or fuel return 109; and/or flow sensors that measure flow rates of the fuel supply 107 and/or fuel return 109, and output these measurements as sensor data. Examples of strain gauges include fiber optic gauges, foil gauges, capacitive gauges, etc. Examples of temperature sensors include fiber optic temperature sensors, heat meters, infrared thermometers, liquid crystal thermometers, resistance thermometers, temperature strips, thermistors, thermocouples, etc. Examples of flow sensors include flow meters, flow loggers, laser-based interferometry devices, Hall Effect sensors, Doppler based devices, etc. The precise location of the sensors 132, 133 may vary in accordance with desired measurement.

For instance, the sensors 132, 133 may be flow sensors that provide precise and instantaneous detection of flow rates of the fuel supply 107 and/or fuel return 109. This precise and instantaneous detection of flow rates enables the measuring system 100 to pull out high frequency readings of the fuel supply 107 and/or fuel return 109 and create sensor data signal output (e.g., a pulse width modulated signal) that includes extreme detail of the operations of the power system 101. The flow sensors may be contactless for ease of installation and ease of adaptation to any power system 101.

In another embodiment, the at least two sensors 132, 133 may further include three voltage and three current sensors coupled to a three-phase alternating current output from the engine 103. These three voltage and three current sensors can be connected to the controller 130, which may also execute additional algorithms on voltage and current data. A combination of the fuel flow and the voltage/current data is utilized by the controller 130 to more particularly derive a complete picture of the power system 101, more accurately detect and predict faults, and effectively isolate a specific location of a failure within the power system 101. Note that while three phase power is described above, embodiments may be applied to single phase or other multiphase systems.

Turning now to FIG. 2, an operational embodiment of the measuring system 100 will now be described with respect to a process flow 200. The process flow 200 begins at block 205 where the sensors 132, 133 (e.g., two fuel flow sensors) output sensor data to the controller 130. For instance, two fuel flow sensors monitor the fuel flow rate to and from the engine 103, respectively. The first fuel flow sensor (e.g., the sensor 132) monitors the fuel flow in the fuel supply 107 from the tank 105 to the engine 103. Further, the second fuel flow sensor (e.g., the sensor 133) monitors the fuel flow in the fuel return 109 from the engine 103 back to the tank 105.

Note that the supply and return of the fuel from the tank 105 is provided by a fuel injection system (not shown). The fuel injection system responds to changes in loads and engine conditions, such as to compensate for fuel loss due to engine combustion, by continuously and instantaneously changing the fuel flow between the sensors 132, 133. This behavior by the fuel injection system creates characteristic signatures.

For example, in the case of a diesel engine, a fuel delivery system utilizes a fuel distributor to squeeze through some injectors a little bit of diesel fuel for each firing of each cylinder of the diesel engine. The squeezing or fuel flow operation creates a rapid signal. The rapid signal is based on an amount of fuel that the diesel engine is demanding for a particular load. As the load changes or conditions inside the diesel engine degrade, the pulse width of a sensor signal fluctuates to reflect the corresponding amount of fuel demanded by the engine.

At block 210, the controller 130 processes the fuel flow rates to derive signature differences. Particularly, the controller 130 receives the flow rates from each sensor 132, 133 and monitors the difference between the engine's 130 in-flow and out-flow. Continuing with the above diesel example, the fluctuations or lack of fluctuations (e.g., signature differences) in the pulse width of the sensor signal are detected.

Next, at block 215, the controller 130 diagnoses the signature differences to detect healthy, degrading, failing, and failed mechanical conditions. Diagnosis, in addition to an indication of the mechanical condition, can include engaging another process that watches the signature differences over time so that a subsequent instruction to perform a further action (e.g., corrective action) may be issued.

To provide a diagnosis, the controller 130 performs various signal process techniques on the sensor data, For example, the controller utilizes an algorithm that analyzes changes in the characteristic signatures, in view of prior operation trends and figures of merit, to detect healthy, degrading, failing, and failed mechanical conditions. The algorithm leverages the notion that the engine 103 consumes more fuel during degradation and prior to functional failure, which causes particular signature differences to be found between the engine's 130 in-flow and out-flow. In this way, the measuring system 100 goes beyond mere flow rate calculations to derive average fuel consumption by performing a specialized deconstruction of the instantaneous signatures of the flow rate to identity a failure progression. The measuring system actually determines what kind of failures or issues are occurring in the power system 101 to determine the health of the engine.

Then, at block 220, the controller 130 determines from these mechanical conditions a prognosis for degradations and failures of all components of the power system 101. A prognosis is a result prediction stemming from the mechanical condition, along with a timeline for when that result will occur. Thus, sensor data extracted and processed from the sensors 132, 133 goes beyond monitoring the fuel flow by yielding a resolution of a future health of multiple systems within the power system 101.

In an embodiment of forming a prognosis, the diagnosis of block 215 may be compared to the power output of the power system 101 via voltage and current sensors over time to perform higher level resolution health prediction. For example, if the power system 101 was a turbine engine of an aircraft during steady flight, the power output of the turbine engine could be fused with mechanical conditions derived from signature characteristics to determine the status and health of the turbine engine. A strain gauge that measures thrust of the turbine engine may also be coupled to the measuring system 100 to further perform higher level resolution diagnostics and prognostics of the turbine engine.

Referring now to FIG. 3, there is shown an embodiment of a processing system 300 (e.g., controller 130 or example of an embedded system) of the measuring system 100 for implementing the teachings herein. In this embodiment, the processing system 300 has one or more central processing units (processors) 301a, 301b, 301c, etc. (collectively or generically referred to as processor(s) 301). The processors 301, also referred to as processing circuits, are coupled via a system bus 302 to system memory 303 and various other components. The system memory 303 can include read only memory (ROM) 304 and random access memory (RAM) 305. The ROM 304 is coupled to system bus 302 and may include a basic input/output system (BIOS), which controls certain basic functions of the processing system 300. RAM is read-write memory coupled to system bus 302 for use by processors 301.

Processing system 300 can further include an input/output (I/O) adapter 306 and a network adapter 307 coupled to the system bus 302. I/O adapter 306 may be a small computer system interface (SCSI) adapter that communicates with a hard disk 308 and/or tape storage drive 309 or any other similar component. I/O adapter 306, hard disk 308, and tape storage drive 309 are collectively referred to herein as mass storage 310. Software 311 for execution on processing system 300 may be stored in mass storage 310. The mass storage 310 is an example of a tangible storage medium readable by the processors 301, where the software 311 is stored as instructions for execution by the processors 301 to perform a method, such as the process flows of FIGS. 2-3. Network adapter 307 interconnects system bus 302 with an outside network 312 enabling processing system 300 to communicate with other such systems. A screen (e.g., a display monitor) 315 is connected to system bus 302 by display adapter 316, which may include a graphics controller to improve the performance of graphics intensive applications and a video controller. In one embodiment, adapters 306, 307, and 316 may be connected to one or more I/O buses that are connected to system bus 302 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 302 via an interface adapter 320 and the display adapter 316. A keyboard 321, mouse 322, and speaker 323 can be interconnected to system bus 302 via interface adapter 320, which may include, for example, a Super I/O chip integrating multiple device adapters into a single integrated circuit.

Thus, as configured in FIG. 3, processing system 305 can include processing capability in the form of processors 301, and, storage capability including system memory 303 and mass storage 310, input means such as keyboard 321 and mouse 322, and output capability including speaker 323 and display 315. In one embodiment, a portion of system memory 303 and mass storage 310 collectively store an operating system to coordinate the functions of the various components shown in FIG. 3.

In view of the above, the measuring system 100 may be duplicated and utilized across multiple power sources in a grid that are sharing a load or switching time sliced of handling a load. The measuring system 100 can be configured to understand a condition one or more of the multiple power sources may have and a relationship the multiple power sources have with each other, such that the measuring system 101 can provide a health management of the multiple power sources (such as in a public utility environment or micro-grid concept). Further, the measuring system 100 may also be applied to regime recognition so as to provide health management of a diesel engine on a commercial truck or boat.

Technical effects and benefits include maintenance and performance benefits based on tracking individual unit fuel consumption and providing operational feedback regarding day to day performance of power systems. That is, because prior and current management of electrical generators consists of manual, periodic inspections and preventative maintenance and overhaul, supplemented by reactive maintenance to field breakdowns, early detection of degradation can inform maintenance and operations that result in a more effective maintenance program with reduced field breakdowns, as well as significant time and cost savings. In addition to the maintenance and performance benefits, operational knowledge of ongoing fuel consumption supports more efficient operations and allocations of power systems. For example, because operation of diesel generators are extreme consumers of fuel on a battlefield, the measuring system may be employed for usage, performance, and condition monitoring on all systems using diesel engines.

Further, the above measuring system supports a distributed data acquisition and processing concept that permits expansion of health and usage monitoring capabilities by leveraging intelligence from other systems, including add-on, networkable monitoring nodes.

The present invention may be a system, a method, and/or a computer program product. The computer program product may include a computer readable storage medium (or media) having computer readable program instructions thereon for causing a processor to carry out aspects of the present invention. The computer readable storage medium can be a tangible device that can retain and store instructions for use by an instruction execution device.

The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A device for computing a health of an engine, the device being communicatively coupled to at least two sensors, a first sensor of the at least two sensors being physically coupled to fuel supply to the engine, a second sensor of the at least two sensors being physically coupled to fuel return from the engine, the device configured to:
receive a sensor data from the at least two sensors that includes an in-flow detected by the first sensor and an out-flow detected by the second sensor;
process the sensor data to derive signature differences; and
diagnose the health of the engine based on the signature differences.

2. The device of claim 1, wherein the sensor data is a precise and instantaneous detection of flow rates into and out of the engine.

3. The device of claim 1, wherein the device is configured to determine from the diagnoses of the health of the engine a prognosis for degradations and failures of the engine.

4. The device of claim 1, wherein the signature differences include fluctuations in the sensor data between the in-flow of the fuel supply and the out-flow of the fuel return.

5. The device of claim 1, wherein the device is configured to:
receive additional sensor data from voltage and current sensors coupled to an electrical output of the engine; and
diagnose the health of the engine based on the signature differences and the additional sensor data.

6. The device of claim 1, wherein the device is coupled with the at least two sensors and the engine in a self-contained smart node system.

7. A method for computing a health of an engine coupled to at least two sensors, a first sensor of the at least two sensors being physically coupled to fuel supply to the engine, a second sensor of the at least two sensors being physically coupled to fuel return from the engine, comprising:
receiving a sensor data from the at least two sensors that includes an in-flow detected by the first sensor and an out-flow detected by the second sensor;
processing the sensor data to derive signature differences; and
diagnosing the health of the engine based on the signature differences.

8. The method of claim 7, wherein the sensor data is a precise and instantaneous detection of flow rates into and out of the engine.

9. The method of claim 7, wherein the method further comprises:
determining from the diagnoses of the health of the engine a prognosis for degradations and failures of the engine.

10. The method of claim 7, wherein the signature differences include fluctuations in the sensor data between the in-flow of the fuel supply and the out-flow of the fuel return.

11. The method of claim 7, wherein the method further comprises:
receiving additional sensor data from voltage and current sensors coupled to an electrical output of the engine; and
diagnosing the health of the engine based on the signature differences and the additional sensor data.

12. The method of claim 7, wherein the method is embodied as computer readable instruction within a non-transitory medium of a device,
wherein the device is coupled with the at least two sensors and the engine in a self-contained smart node system.
